(19) United States
(12) Patent Application Publication
(10) Pub. No.: US 2003/0206310 A1
(43) Pub. Date: Nov. 6, 2003

(54) Integrated scanner/printer driver and related methodology

(76) Inventor: Andrew Rodney Ferlitsch, Tigard, OR (US)

Correspondence Address: David C. Ripma, Patent Counsel, Sharp Laboratories of America, Inc., 5750 NW Pacific Rim Boulevard, Camas, WA, 98607, US

(21) Appl. No.: 10/138,330

(22) Filed: May 3, 2002

(51) Int. Cl. G06F 15/00; B41J 1/00

(52) U.S. Cl. 358/1.13

(57) ABSTRACT

A single, integrated multi-function driver which, when invoked, has the capability to afford driver control over the operations of a scanner and a printer, such as the scanner and printer component portions of an otherwise conventional MFP device. The integrated driver included both a scanner driver and a printer driver, and in an enhanced form, further includes specialized portions which enable scan modification and manipulation, as well as print modification and manipulation.

### BACKGROUND AND SUMMARY OF THE INVENTION

This invention relates to an integrated driver which is functional to control the operations both of a scanning device and of a printing device under the aegis of a single unified driver. A preferred embodiment of the invention is illustrated herein with reference to operating and manipulating the performance of a multi-function printer, known as an MFP device, and in this setting, is referred to as an integrated, singular MFP driver.

While this preferred embodiment and manner of practicing the invention are described in relation to an integrated MFP driver for use in conjunction with an MFP device, it is recognized that features of the invention have applicability in settings other than those which involve a MFP device.

Proceeding then with an MFP device as an area of activity wherein to describe the present invention, typical MFP devices have separate scanner and printer drivers that are associated with the scanners and printers that reside within them. With respect to user operation of an MFP device, say, from the control point of view of a connected computer, the user typically initiates one or the other of these two drivers depending upon the specific current function which the user wishes to implement. It is very typical that each of these two different drivers for the two different (scanner and printer) devices are invoked through the use of different specific user applications, and with respect to invocation of the respective, conventionally separate drivers, a user may be provided, and often is provided, with opportunities for initiating specific specialized controls, manipulations and modifications in relation to the ways in which scanning and printing take place. Terminology which is employed herein to refer to these kinds of controls and manipulations includes the phrase “scan modification” or “modifier”, “print modification” or “modifier”, and like terminology.

To date, no integrated driver has existed which can be invoked as a singularity and which, upon invocation, and by that action alone, opens access for effective driver control over scanning and printing functions as part of an integrated approach toward a scanning and printing operation. The present invention significantly addresses this short-coming in the prior art by proposing a novel and extremely useful integrated driver which can be invoked as a singularity, and which includes components that are specific for acting, on the one hand as a scanner driver, and on a related and other hand, as a printer driver. Additionally, a preferred embodiment and manner of practicing the invention includes not only the offering of a single, combined integrated driver having the functionality just generally outlined, but which also includes capabilities for introducing modifier and modification operations both in the region of scanning and in the region of printing manipulation. In other words, invocation of a single combined integrated driver, according to the invention, provides immediate access both for driver control of scanning and of printing operations, and additionally affords user access to various otherwise customarily available, but not integrated, capabilities for manipulating text and imagery, and including print preview.

The accompanying drawings, descriptions of which are now generally given below, fully characterize for those skilled in the art, all of the basic structural and operational features of the method and system of the present invention. That method and system can be fully implemented by such a person skilled in the art reading this text disclosure along with the illustrative drawings.

Various other features and advantages that are offered by the invention, in addition to those which have just been suggested above, and which are somewhat amplified in text below, will become more fully apparent as the detailed description of the invention which now follows is read in conjunction with the accompanying drawings.

### DESCRIPTION OF THE DRAWINGS

FIG. 1 is a block/schematic diagram generally illustrating the logic and architecture of the present invention, including a suggestion relating to the fact that a preferred embodiment of the invention has been found to offer particular utility in the field of so-called MFP devices.

FIG. 2 is a block/schematic diagram directly illustrating the present invention in the setting of an otherwise conventional MFP device, and further illustrating scan and print modifiers that are preferably incorporated into a preferred embodiment and manner of practicing the invention.

FIG. 3 is a more detailed block/schematic overview of an integrated MFP driver constructed and functioning according to the invention.

FIG. 4 is a block/schematic diagram illustrating image capture utilizing the MFP driver detailed in FIG. 3.

FIG. 5 is a more detailed block/schematic diagram illustrating the architecture and methodology of imaging segmentation and separation performed in accordance with what is more generally shown in FIG. 3.

FIG. 6 is a block/schematic diagram further detailing segmenting and separation for pipeline feeding into the printer driver portion of the integrated MFP driver generally shown in FIG. 3.

FIG. 7 is a more detailed block/schematic diagram illustrating print manipulation performed in accordance with one embodiment and manner of practicing the invention as such as disclosed in FIG. 3.

FIG. 8 is a detailed/block/schematic diagram illustrating sheet assembly/despooling performed in accordance with the system and methodology set forth generally in FIG. 3.

### DETAILED DESCRIPTION OF THE INVENTION

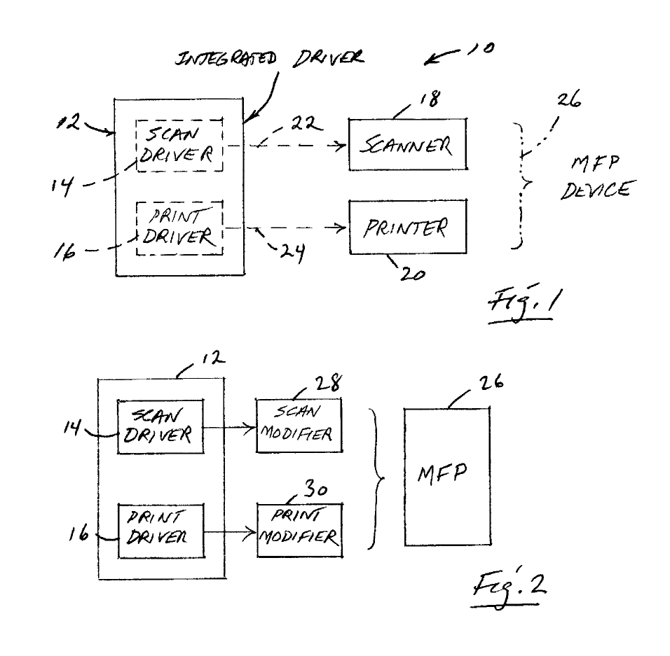

Turning now to the drawings, as was referred to earlier herein, a very full understanding of the logic, the architecture and the unique methodology proposed and offered by the system and methodology of the present invention are very fully described visually in the eight drawing figures which are presented herein. Those skilled in the art reviewing these figures will come to a full understanding of how to implement and practice the present invention, without there being much requirement for additional verbal description. Accordingly the text material which now follows in relation to discussions involving FIGS. 1-8, inclusive, proceeds along this line.

Indicated generally at 10 in FIG. 1 is an integrated driver methodology and system constructed in accordance with a general overview of the special offerings made by the present invention. Included as shown in this figure is a unique integrated driver 12 which is constructed in accordance with the invention to include a scan driver component 14 and print driver component 16. In a very broad sense, integrated driver 12 is fundamentally made up of the integrated combination of scan driver 14 and print driver 16 which have been designed to implement control and management over the respective operations of a scanner 18 and of a printer 20. Dashed arrows 22, 24 illustrate the operative connections which exist in FIG. 1 between scan driver 14 and scanner 18, and between print driver 16 and printer 20, respectively.

While it should be understood that an integrated driver 12 including a scan driver 14 integrated with a print driver 16 can be established for use with any particular selected scanner 18 and any particular selected printer 20, a preferred environment wherein such an integrated driver has special utility involves the environment of a so-called multi-function printer device, also referred herein as an MFP device. In FIG. 1, dash-double-dot bracket 26 represents the unifying of a scanner such as scanner 18 and a printer such as printer 20 within a specific MFP device.

According to the invention, when a user, with reference to what is shown in FIG. 1, invokes integrated driver 12, he or she is immediately provided with use access to scan driver 14 and to print driver 16, effectively in the setting of a common interface environment so that all operations relative to control over the performance of scanner 18 and over the performance of printer 20 are available without the invocation of any further other driver settings. This arrangement is especially useful, as one will appreciate, in the setting of controlling an MFP device from a suitably connected control device, such as a computer.

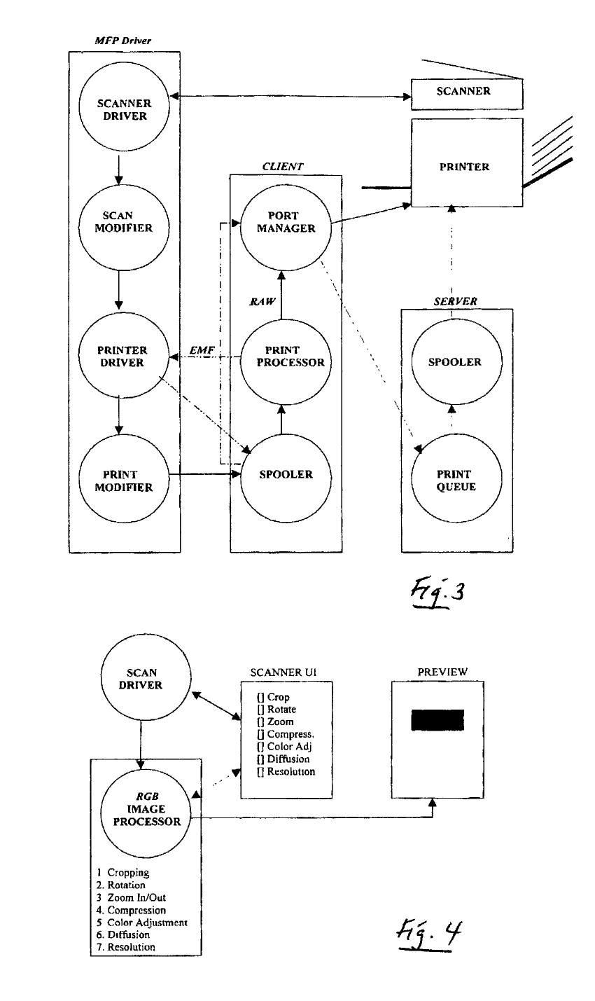

According an enhanced preferred embodiment of the invention, and directing attention now to FIG. 2 which specifically shows the integrated driver of the present inventions associated with an MFP device 26, also incorporated as close operative companions to the scan driver and the print driver in integrated driver 12 are scan modifier and print modifier software constructions 28, 30 respectively, which are also made available to a user who invokes MFP driver 12. As will be more fully explained shortly, especially by the graphic and visual contents of FIGS. 3-8 inclusive, scan modifier 28 and print modifier 30 offer a user, within the realm of singular invocation of MFP driver 12, a host of widely recognized, desirable control, manipulation and modification and preview opportunities with respect to the contents (visual and text) of a document which is to be scanned in and printed by MFP device 26 in FIG. 2.

Continuing now with reference next to FIG. 3, it is understood that the system of the present invention may be employed in conjunction with one or more MFP devices, which devices may be connected locally, in a network, or in a peer-to-peer printing environment. Invocation of the MFP integrated driver of the present invention can occur locally, over a network, or by a remote computing device which is capable of initiating the scanning of an image or documents with text and imagery, and which is capable of despooling a print Job to a spooler, and optionally to a print processor ultimately to an appropriate MFP device. FIG. 3 in the drawings shows, in the upper right corner, a single MFP device including a scanner and a printer, and the remainder of this figure is an operational and structural description of how the system and methodology of this invention can be employed with respect to the operation of this scanner and printer.

In the arrangement pictured in FIG. 3, a user invokes the MFP driver from within an application in an appropriate computer, by a stand alone process, or by any suitable automated process. The specific MFP driver illustrated in FIG. 3 here consists of four integrated components, including a scanner driver, a scanned image modification module (a scan modifier), a printer driver, and a print data modification module (or print modifier). The MFP driver pictured in FIG. 3 would typically reside on an appropriate computing device from which invocation takes place. In an alternative arrangement, part or all of the integrated MFP driver may reside on a remote computing device with a remote user interface (i. e., a server).

The various operational routes that flow from invocation of the MFP driver pictured in FIG. 3 are clearly presented in this figure, and it will apparent how the proposed integrated MFP driver thus conveniently offers a user the opportunity to initiate, control and perform a multitude of functions which, in conventional structure, would require multiple driver invocations and a significantly less convenient and more time-consuming process.

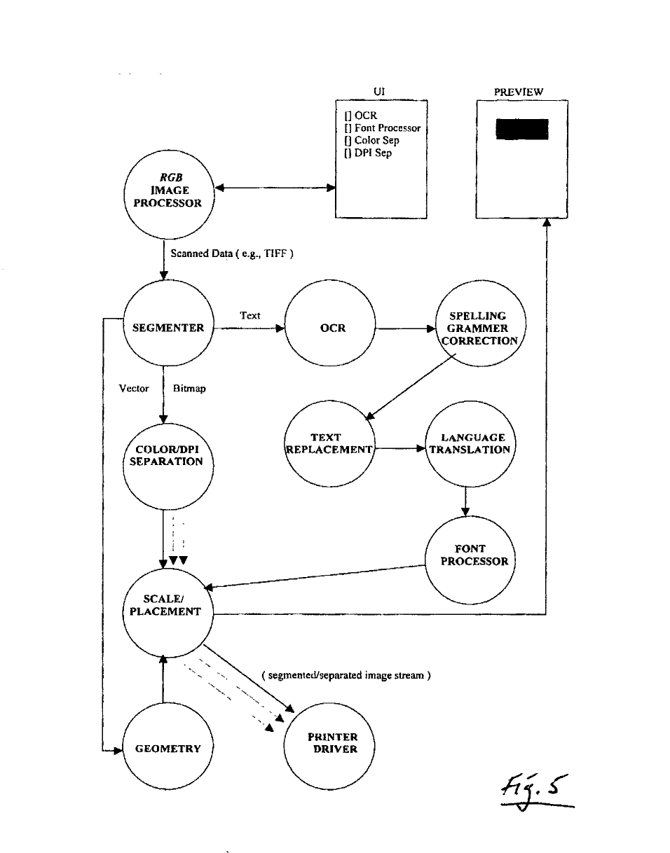

FIG. 4 in the drawings illustrates an early phase of operation of the MFP scanner driver in the overall utility of the MFP integrated driver, and specifically focuses attention on the capturing of an image, accompanied by the opportunity to initiate various image control procedures, such as cropping, rotating, zooming, color adjusting, etc. FIG. 4 specifically illustrates how the special integrated MFP driver pictured in FIG. 3 can lead to a high-level pre-printing preview as illustrated by the content in FIG. 4.

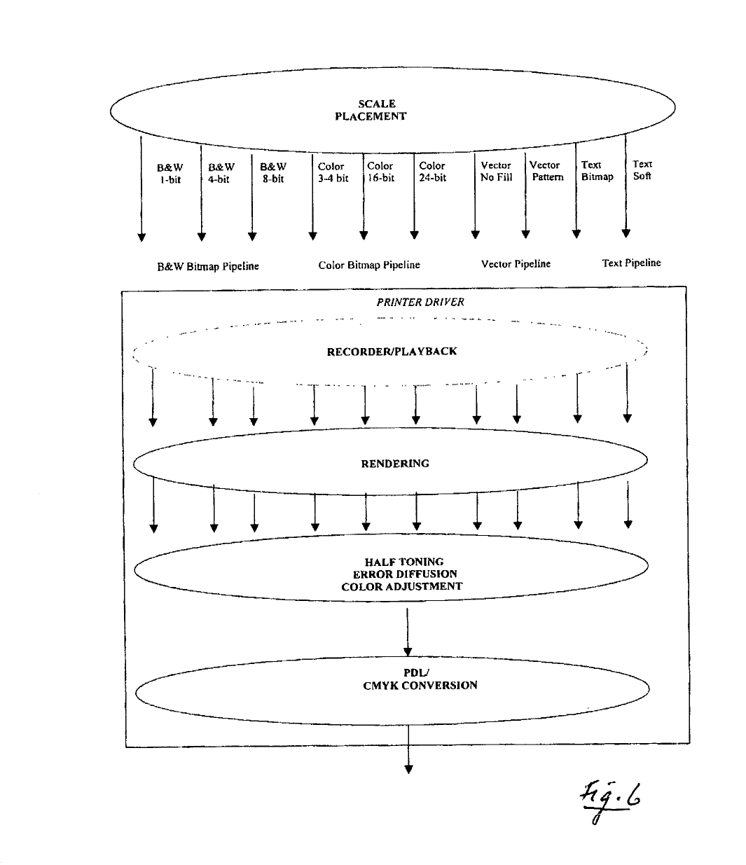

FIGS. 5 and 6 illustrate a later phase resulting from invocation of the MFP integrated driver, and namely a segmentation/separation phase which can include various image manipulations that are specific to a particular segmentation type. The block and circle components presented in FIG. 5, along with the text information given in this drawing figure, clearly illustrate the utility and versatility offered with respect to segmentation and separation of an image according to practice of the present invention.

FIGS. 5 and 6 plainly illustrate how the results of various image manipulations can result in a high-level preview for a user, and also clearly demonstrates the capability, according to practice of the invention, of pipelining information into the printer driver component portion of the MFP integrated driver.

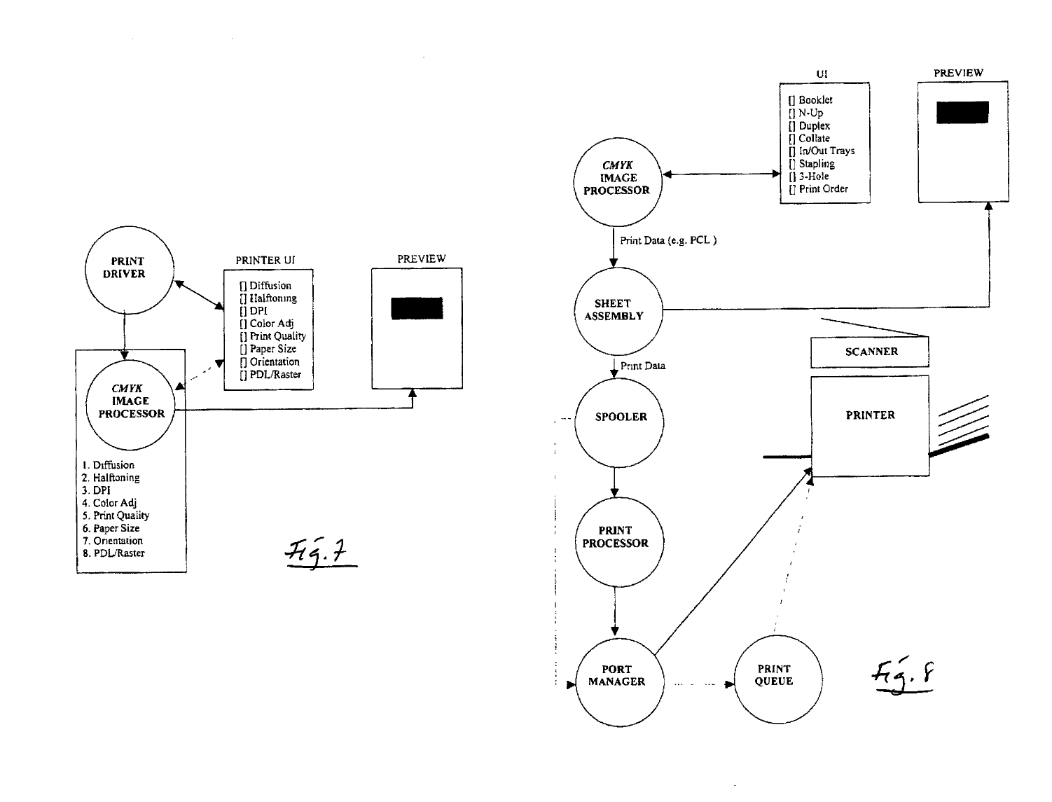

FIG. 7 in the drawings specifically illustrates the capabilities for various print manipulations that can be performed under the control of, and after invocation of, the singular integrated MFP driver of FIG. 3. The specific phase of operation according to the invention which is pictured in this figure can include a wide range of steps including error diffusion, half toning, DPI control, color adjustments, print quality adjustments, paper size and image orientation considerations, and output format, for examples.

FIG. 8 in the drawings illustrates that phase of printing operation which involves sheet assembly and despooling of a modified print data stream. This phase may include steps such as page scaling, placement and finishing. Page scaling and placement can include booklet printing, tablet printing, duplex, and N-up procedures. Finishing can include collation, selection of the number of copies, the print order, stapling, hole punching, and delivery in a specific fashion to/from input/output trays,

It will thus be apparent, that the advance proposed by the system and methodology of the present invention, which involves the creation of an integrated single driver whose invocation offers control access to scanning and printing. to scanning and printing modifications, and to print previewing, furnishes significant improvements in terms of efficiency and practical utility with respect to computer-controlled scanning and printing. Especially the system and methodology of the invention offer a significant improvement in the area of controlling scanning and printing in the widely used multi-function type of device which is referred to an MFP device.

Accordingly, while a preferred embodiment, and some enhanced modifications, of an integrated driver, and specifically of an MFP-capable integrated driver, have been disclosed and illustrated herein, other variations and modifications are entirely possible which come within the scope of the present invention.

I claim:

1. An MFP document-scanning/printing system comprising
an MFP device having a scanner, and a printer, and
an integrated MFP driver operatively associated both with said scanner and with said printer, and including, effectively within the MFP driver per se, an integrated scanner driver and printer driver each operatively associated respectively with said scanner and said printer.

2. The system of claim 1, wherein said integrated MFP driver includes scan modification and control software operatively linked to said scanner driver.

3. The system of claim 1, wherein said integrated MFP driver includes print modification and control software operatively associated with said printer driver.

4. The system of claim 1, wherein said integrated MFP driver includes both scan modification and control software and print modification and control software operatively associated, respectively, with said scanner driver and said printer driver.

5. A method employable with an MFP device having a scanner and a printer comprising
furnishing a scanner driver for the control of the scanner,
furnishing a printer driver for the control of the printer, and
integrating the provided scanner driver and printer driver as portions of a unified MFP driver whose invocation opens user access substantially simultaneously to both said scanner driver and said printer driver.

6. The method of claim 5, wherein the unified MFP device provides access to image manipulation modalities, and to print previewing.

7. The method of claim 6, wherein image modalities may include, inter alia one or more of resolution, cropping, rotation, zooming, compressing, color adjusting, diffusion, font processing and scaling, and page scaling, placement and finishing.

8. A document scanning/printing system comprising
a scanner,
a printer operatively connected to said scanner, and
an integrated driver including a scanner driver component and a printer driver component operatively associated, respectively, with said scanner and said printer.
